(19) United States
(12) Patent Application Publication
(10) Pub. No.: US 2026/0268288 A1
(43) Pub. Date: Sep. 10, 2026

(54) INFORMATION PROCESSING APPARATUS, AND INFORMATION PROCESSING METHOD

(71) Applicant: Suntory Holding Limited, Osaka City, Osaka (JP)

(72) Inventor: Takayuki Inoue, Tokyo (JP)

(73) Assignee: Suntory Holding Limited, Osaka City, Osaka (JP)

(21) Appl. No.: 19/166,991

(22) PCT Filed: Mar. 7, 2024
(86) PCT No.: PCT/JP2024/008881

§ 371 Date: Sep. 19, 2025

(30) Foreign Application Priority Data
Mar. 20, 2023 (JP) 2023-043729

(51) Int. Cl. G06Q 10/30; G06N 20/00

(52) U.S. Cl. CPC G06Q 10/30; G06N 20/00

(57) ABSTRACT

71 In order to solve the problem that it is difficult for conventional techniques to assist in deterring the removal of installed offering apparatuses 3, an information processing apparatus 1 includes: a score acquisition unit 132 that acquires a removal score regarding the removal of an offering apparatus 3 such as a vending machine that offers an article such as a beverage, the removal score being acquired using one or more attribute values of the offering apparatus 3 and a score output unit 141 that outputs the removal score acquired by the score acquisition unit 132. Accordingly, it is possible to a in deterring the removal of installed offering apparatuses 3.

### TECHNICAL FIELD

The present invention relates to an information processing apparatus and the like for outputting information on the removal of offering apparatuses.

### BACKGROUND ART

Recently, there are delivery planning apparatuses that use machine learning to create an efficient delivery route that suppresses the decline in sales of vending machine products due to sellouts while suppressing the increase in delivery time (see Patent Document 1).

### CITATION LIST

### Patent Document

Patent Document 1: JP 2022-190579A

### SUMMARY OF INVENTION

### Technical Problem

However, it has not been possible for conventional techniques to assist in deterring the removal of installed offering apparatuses. The offering apparatuses are, for example, vending machines, but a detailed description thereof will be described later.

### Solution to Problem

A first aspect of sent invention is directed to an information processing apparatus including: a score acquisition unit that acquires a removal score regarding removal of an offering apparatus that offers an article, the removal score being acquired using one or more attribute values of the offering apparatus; and a score output unit that outputs the removal score acquired by the score acquisition unit.

With this configuration, it is possible to assist in taking measures to deter the removal of an offering apparatus, by outputting a removal score thereof.

Furthermore, a second aspect of the present invention is directed to the information processing apparatus according to the first aspect, further including an attribute value acquisition unit that acquires one or more attribute values of an offering apparatus; an improvement acquisition unit that acquires improvement information for preventing removal of the offering apparatus, using the one or more attribute values acquired by the attribute value acquisition unit; and an improvement output unit that outputs the improvement information acquired by the improvement acquisition unit.

With this configuration, it is possible to output improvement information for deterring the removal of an offering apparatus.

Furthermore, a third aspect of the present invention is directed to the information processing apparatus according to the second aspect, wherein the improvement acquisition unit includes: an improvement model acquisition part that acquires an improvement learning model acquired using two or more pieces of training data each having or more attribute values of an offering apparatus and result information regarding removal obtained by implementing improvement indicated by improvement information; an improvement prediction part that performs prediction processing of machine learning using the one or more attribute values acquired by the attribute value acquisition unit and the improvement learning model and an improvement acquisition part that acquires improvement information, using results of the prediction processing performed by the improvement prediction part.

With this configuration, it is possible to output improvement information for deterring the removal of an offering apparatus, using machine learning.

Furthermore, a fourth aspect of the present invention is directed to the information processing apparatus according to the second aspect, wherein the improvement acquisition unit includes: an improvement model acquisition part that, for each piece of improvement information, acquires an improvement learning model acquired using two or more pieces of training data each having one or more attribute values of an offering apparatus and result information regarding removal obtained by implementing improvement indicated by improvement information; an improvement prediction part that, for each piece of improvement information, performs prediction processing of machine learning using the one or more tribute values acquired by the attribute value acquisition. unit and the improvement learning model paired with the improvement information; and an improvement acquisition part that acquires one or more pieces of improvement information, using results of the prediction processing performed by the improvement prediction part.

With this configuration, it is possible to output improvement information for deterring the removal of an offering apparatus, using machine learning.

Furthermore, a fifth aspect of the present invention is directed to the information processing Aratus according to the second aspect, wherein the improvement acquisition unit includes: a standard acquisition part that acquires standard attribute values respectively for one or more attributes of an offering apparatus, from a standard management unit in which the standard attribute values respectively for the one or more attributes are stored; an attribute determination part that respectively compares, for the one or more attributes of the offering apparatus, the attribute values acquired by the attribute value acquisition unit and the standard attribute values, and determines defectiveness attributes; and an improvement acquisition part that acquires pieces of improvement information respectively corresponding to the defectiveness attributes.

With this configuration, it is possible to output improvement information for deterring the removal of an offering apparatus, using standard attribute values of the offering apparatus.

Furthermore, a sixth aspect of the present invention is directed to the information processing apparatus according to any one of the first to fifth aspects. wherein the score acquisition unit includes: a score model acquisition part that acquires a score learning model acquired using two or more pieces of training data each having one or more attribute values and a removal score; and as score acquisition part that acquires the removal score by performing prediction processing of machine learning using the one or more attribute values of the offering apparatus subjected to removal score acquisition and the score learning model.

With this configuration, it is possible to assist in taking measures to deter the removal of an offering apparatus, by outputting a removal score thereof, using machine learning.

Furthermore, a seventh aspect of the present invention is directed to the information processing apparatus according to any one of the first to fifth aspects, wherein the score acquisition unit includes a vector acquisition part that acquires a vector based on the one or more attribute values of the offering apparatus subjected to removal score acquisition; and a score a acquisition part that, referring to a correspondence table containing two or more pieces of correspondence information each having a vector based on one or more attribute values of an offering apparatus and a removal score, acquires the removal score of the offering apparatus, using a removal score paired with a vector that satisfies a similarity condition to the vector acquired by the vector acquisition part.

With this configuration, it is possible to assist in taking measures to deter the removal of an offering apparatus, by outputting a removal score thereof, using a correspondence table.

Furthermore, an eighth aspect of the present invention is directed to the information processing apparatus according to any one of the first to fifth aspects, wherein the score acquisition unit includes: a score acquisition part that acquires the removal score, by substituting each of the one or more attribute values of the offering apparatus subjected to removal score acquisition, for an operation expression, and executing the operation expression.

With this configuration, it is possible to assist in taking measures to deter the removal of an offering apparatus, by outputting a removal score thereof, using an operation expression.

Furthermore, a ninth aspect of the present invention is directed to the information processing apparatus according to any one of the first to eighth aspects, wherein the offering apparatus is a vending machine, each of the one or more attribute values is a dynamic attribute value or a static attribute value, the dynamic attribute value is sales related information, the number of visits, the number of inquiries, the number of product changes, the number of setting changes, contact person information, operating information, a contract duration, or a remaining contract period, the static attribute value is hardware information of the offering apparatus or installation location information of the offering apparatus, the hardware information is presence or absence of a cashless purchase method, presence or absence of user terminal communication support, presence or absence of management communication, year, the number of products that can be offered, the quantity of products that can be sold, accessory equipment information, power consumption, presence or absence of disaster support, presence or absence of signage, an equipment manufacturer, or presence or absence of a specific feature, and the installation location information is information for specifying place of purchase, information for specifying a floor, information for specifying an indoor or outdoor location, an address, counterparty information, or adjacent setup combined selling information.

With this configuration, it is possible to assist in taking measures to deter the removal of an offering apparatus, by outputting a removal score thereof.

### Advantageous Effects of Invention

With the information processing apparatus according to the present invention, it is possible to assist in deterring the removal of installed offering apparatuses.

### BRIEF DESCRIPTION OF DRAWINGS

FIG. 1 is a conceptual diagram of an information system A in Embodiment 1.

FIG. 2 is a block diagram of the information system A in the embodiment.

FIG. 3 is a flowchart illustrating an operation example of an information processing apparatus 1 in the embodiment.

FIG. 4 is a flowchart illustrating a first example of score acquisition processing in the embodiment.

FIG. 5 is a flowchart illustrating a second example of score acquisition processing in the embodiment.

FIG. 6 is a flowchart illustrating a first example of improvement acquisition processing in the embodiment.

FIG. 7 is a flowchart illustrating a second example of improvement acquisition processing in the embodiment

FIG. 8 is a flowchart illustrating a third example of improvement acquisition processing in the embodiment.

FIG. 9 is a flowchart illustrating an operation example of a learning apparatus 4 in the embodiment.

FIG. 10 is a diagram showing an apparatus management table in the embodiment.

FIG. 11 is a diagram showing a standard management table in the embodiment.

FIG. 12 is a diagram showing an improvement table in the embodiment.

### DESCRIPTION OF EMBODIMENT

Hereinafter, an embodiment of an information processing apparatus and the like will be described with reference to the drawings. It should be noted that constituent elements denoted by the same reference numerals in the embodiments perform similar operations, and thus a description thereof may not be repeated.

### Embodiment 1

In this embodiment, an information processing apparatus will be described that acquires a removal score regarding the removal of an offering apparatus using one or more attribute values of the offering apparatus, and outputs the removal score. In this embodiment, an information processing apparatus will be described that acquires the removal score through prediction processing of machine learning, and outputs the removal score. In this embodiment, an information processing apparatus will be described that acquires the removal score using a correspondence table, and outputs the removal score. Furthermore, in this embodiment an information processing apparatus will be-described that acquires the removal score using an operation expression, and outputs the removal score.

Furthermore, in this embodiment, an information processing apparatus will be described that acquires and outputs improvement information that is useful for preventing the removal. In this embodiment, an information processing apparatus will be described that acquires the improvement information through prediction processing of machine learning using a learning model acquired using training data based on results regarding the removal obtained after implementing improvement indicated by improvement information, and outputs the improvement information. In this embodiment, an information processing apparatus will be described that acquires and outputs improvement information corresponding to an attribute value that is inferior to a standard attribute value among one or more attribute values of an offering apparatus.

In this embodiment, the state in which information X is associated with information Y means that the information Y can be acquired from the information X or the information X can be acquired from the information Y, and there is no limitation on the method for associating the information. The information X and the information Y may be linked to each other or in the same buffer The information X may be contained in the information Y, or the information Y may be contained in the information X, for example.

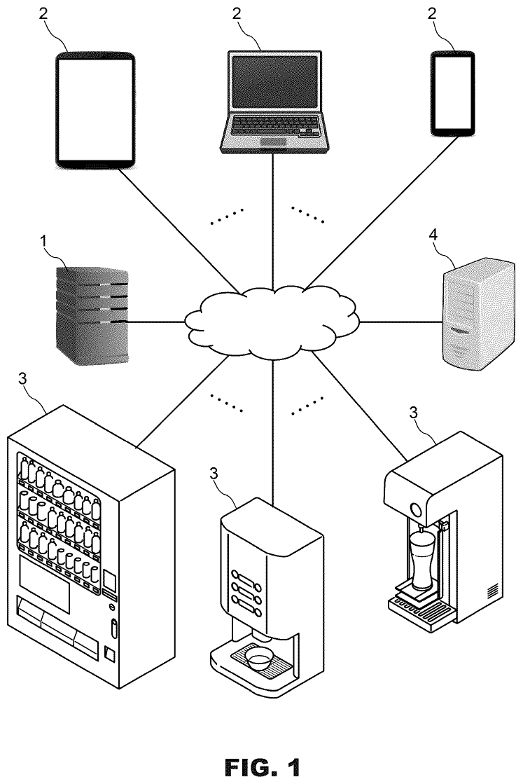

FIG. 1 is a conceptual diagram of an information system A in this embodiment. The information system A includes an information processing apparatus 1, one or two or more terminal apparatuses 2, and one or two or more offering apparatuses 3. The information system A may include a learning apparatus 4.

The information processing apparatus 1 is an apparatus that assists in deterring the removal of the installed offering apparatuses 3, The information processing apparatus 1 is n apparatus that outputs a later described removal score or outputs later described improvement information. The information processing apparatus 1 is typically a server. The information processing apparatus 1 is, for example, a cloud server or an ASP server, but there is no limitation on the type thereof. The information processing apparatus 1 may be a stand-alone apparatus as will be described later.

The terminal apparatuses 2 are apparatuses that are used by users. The user are people who need information on the removal of the offering apparatuses 3. The terminal apparatuses:, for ex sample, so called personal computers, tablet terminals, or smartphones, but there is no limitation on the type thereof.

The offering apparatuses 3 are apparatuses that offer articles to consumers. The article are typically items that are to be sold, but they may be items that are provided free of charge. The articles are typically food, but may be toys or the like. The food is, for example, beverages, but it may be rice. seasonings, or the like, and there is no limitation on the type thereof. The beverages are, for example, water, tea, coffee, beer, Japanese sake, or the like, but there is no limitation on the type thereof The offering apparatuses 3 are, for example, vending machines, but they may be beer servers, tea serving machines, or the like, and there is no limitation on the type thereof.

The learning apparatus 4 is an apparatus that acquires a later described score learning model through learning processing of machine learning, and accumulates the score learning model. The learning apparatus 4 is an apparatus that acquires a later described improvement learning model through learning processing of machine learning, and accumulates the improvement learning model. The learning apparatus 4 is, for example, a so called personal computer, tablet terminal, smartphone, or server, but there is no limitation on the type thereof.

It is preferable that the information processing apparatus 1 and each of the one or more terminal apparatuses 2, and the information processing apparatus 1 and each of the one or more offering apparatuses 3 can communicate with each other via a network such as the Internet.

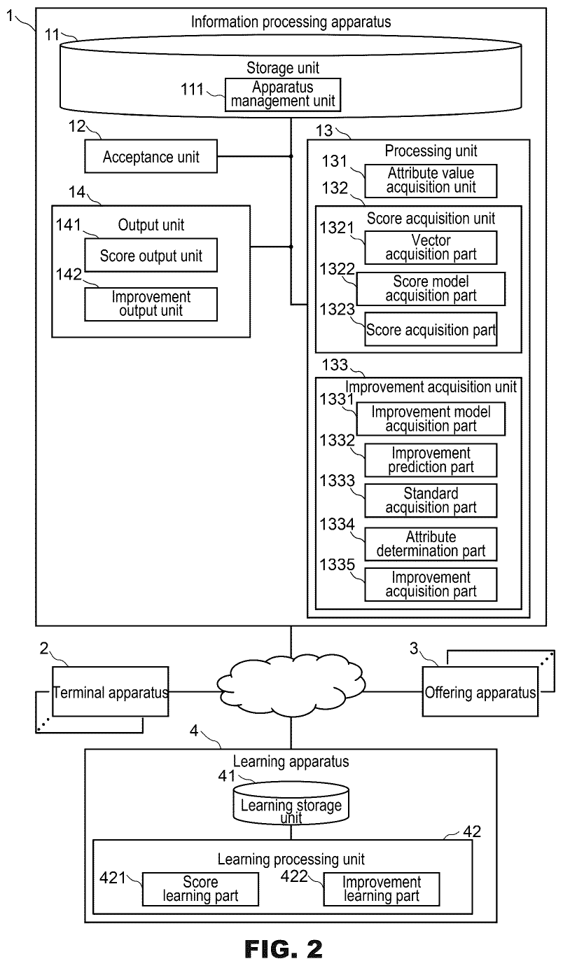

FIG. 2 is a block diagram of the information system A in this embodiment.

The information processing apparatus 1 includes a storage unit 11, an acceptance unit 12, a processing unit 13, and an output unit 14. The storage unit 11 includes an apparatus management unit 111, a standard management unit 112, and an improvement management unit 113. The processing unit 13 includes an attribute value acquisition unit 131, a score acquisition unit 132, and an improvement Requisition unit 133. The score acquisition unit 132 includes a vector acquisition part 1321, a score model acquisition part 1322, and a score. acquisition part 1323. The improvement acquisition unit 133 includes an improvement model acquisition part 1331, an improvement prediction part 1332, a standard acquisition part 1333, an attribute determination part 1334, and an improvement acquisition part 1336. The output unit 14 includes a score output unit 141 and an improvement output unit 142.

Various types of information are stored in the storage unit 11 constituting the information processing apparatus 1. The various types of information are, for example, later described apparatus information, later described improvement information, later described one or more standard attribute values, various learning models, a later described correspondence table, or a later described operation expression. The improvement information is for example, associated with an improvement information identifier. The improvement information identifier is information for identifying improvement information. The improvement information identifier is, for example, an ID of improvement information.

One or two or more pieces of apparatus information are stored in the apparatus management unit 111. The apparatus information is information on the offering apparatuses 3. The apparatus information is typically associated with an apparatus identifier. The apparatus identifier is information for identifying an offering apparatus 3. The apparatus identifier is, for example, an ID. The apparatus information typically has one or more attribute values. The attribute values are attribute values of the offering apparatus 3. Each of the one or more attribute values contained the apparatus information is typically a dynamic attribute value or a static attribute value.

The dynamic attribute value is information that changes dynamically. The dynamic attribute value is, for example, sales related information, the number of visits, the number of inquiries, the number of product changes, the number of setting changes in the offering apparatus 3, contact person information (e.g., a personal history of the cumulative number of people for support), operating information (e.g., a malfunction history of the time required for repair), a contract duration, a remaining contract period, sell-out time, or operation period information.

The sales-related information is information on sales of articles offered by the offering apparatus 3. The sales-related information is, for example, the total sales amount, the sales amount for a unit period (e.g., one month), the total number of sales, the number of sales for the unit period, or the ratio of sales to the previous year's sales.

The number of visits is the number of times that an operator has visited the location where the offering apparatus 3 is installed. The visits are, for example, visits for sales support, visits for delivery, visits for equipment maintenance, visits for installation of advertisements, visits for sales activities for purpose of introducing new products, or the like. The number of visits may be, for example, the number of visits associated with each of two or more pieces of visit type information. The visits are, for example, visits by a contact person who is an operator. The visit type information is, for example, information indicating visits for sales support, information indicating visits for delivery, information indicating visits for equipment maintenance, information indicating visits for installation of advertisements, or information indicating visits sales activities for the purpose of introducing new products. The equipment maintenance is, for example, the repair of the offering apparatus 3 or the change of dummies.

The number of inquiries is the number of times that inquiries have been made to the organization that has provided the offering apparatus 3. The inquiries are, for example, inquiries by e-mail, inquiries by telephone, inquiries by web interview, or the like. The number of inquiries may be the total number of inquiries to date or the number of inquiries in a unit period. The number of inquiries may be the number of inquiries per type of inquiry. The number of inquiries per type of inquiry is, for example, the number of inquiries by e-mail, the number of inquiries by telephone, or the number of inquiries by web interview.

The number of product changes is e number of times that products that are to be sold (e.g., columns) have been changed in the offering apparatus 3 (e.g., a vending machine). The number of product changes may be the total number of product changes to date or the number of product changes in a unit period.

The number of setting changes is the number of times that the settings of the offering apparatus 3 have been changed. A change in setting is, for example, a change in price, a change in temperature setting, or the installation of an optional feature.

The contact person information is information on a contact person. The contact person information is, for example, a personal history or the cumulative number of people for support.

The operating information is information on the operation of the offering apparatus 3. The operating information is, for example, a malfunction history of the offering apparatus 3 or the time required for repair thereof.

The contract duration is the period of time from the start of the contract to install the offering apparatus 3 to the present, and is the period of time during which the contract is ongoing.

The remaining contract period is the period of time remaining in the term. of the contract to install the offering apparatus 3.

The operation period information is information for specifying the operation period of the offering apparatus 3. The operation period information is, for example, the number of months of operation or the number of years of operation.

The static attribute value is an attribute value that does not change dynamically. The static attribute value is, for example, hardware information, installation location information, or presence or absence of sponsorship money.

The hardware information is information on the hardware of the offering apparatus 3. The hardware information is, for example, presence or absence of a cashless purchase method, presence or absence of user terminal communication support, presence or absence of management communication, year (year of manufacture of the year of installation), the number of products that can be offered, the quantity of products that can be sold, accessory equipment information, power consumption, presence or absence of disaster support, presence or absence of signage, an equipment manufacturer, or presence of absence of a specific feature. The specific feature is, for example, a lottery feature that allows users to participate in a lottery system that randomly awards free products after purchase of products, but there is no limitation to this. The presence or absence of user terminal communication support is presence of absence of a wireless communication part for information communication for the purpose of sales promotion between the offering apparatus 3 (e.g., a vending machine) and a user terminal (not shown). The presence absence of management communication is presence of absence of a wireless communication part for information communication for the purpose of managing sales information between the offering apparatus 3 (e.g., a vending machine) and the information processing apparatus 1 or a sales information management server (not shown) or a contact person's terminal (not shown) . The accessory equipment information is, for example, whether or not a recycle box is installed at the vending machine and whether or not a bench is installed.

The installation location information is information on the installation location. The installation location information is, for example, information for specifying place of purchase, information for specifying a floor, information for specifying an indoor or outdoor location, an address, counterparty information, or adjacent-setup combined-selling information. The counterparty information is information on a user who uses the offer apparatus 3, and is, for example, information indicating the number of users o the relationship between the operator side and the users of the offering apparatus 3. The adjacent setup combined selling information is information on adjacent setup or combined selling, and is, for example, information indicating whether or not a competing apparatus is installed or the number of competing apparatuses.

Standard attribute values respectively for one or two or more attributes are stored in the standard management unit 112. The attributes are attributes of the offering apparatus 3. The standard attribute values are attribute values each serving as a standard. The standard attribute values may also be said to be attribute values each serving as a reference, The standard attribute values are typically associated with attribute identifiers, respectively The attribute identifiers are information for respectively identifying attributes. The attribute identifiers are, for example, attribute names or attribute IDs.

One or two or more pieces of improvement information are stored in the improvement management unit 113. The one or more pieces of improvement information are, for example, respectively associated with attribute identifiers.

The improvement information is information for preventing the removal of the offering apparatus 3. The improvement information is, for example, information indicating measures to prevent the removal of the offering apparatus 3. The measures for example, replacing equipment, sending e-mails, or conducting surveys.

The acceptance unit 12 accepts various types of ins ructions and information. The acceptance unit 12 typically receives various types of instructions and information from the terminal apparatuses 2 or the offering apparatuses 3 Note that the acceptance unit 12 may accept various types of instructions and information from users. The various types of instructions and information are, for example, score output instructions, improvement output instructions, or one or more attribute values.

The acceptance unit 12 receives, for example, a score output instruction or an improvement output instruction from a terminal apparatus 2. The acceptance unit 12 receives, for example, one or more attribute values from an offering apparatus 3, in association with the apparatus identifier of the offering apparatus 3.

The score output instruction is an instruction to output removal scores of one or two or more offering apparatuses 3. The score output instruction has, for example, the respective apparatus identifiers of the one or two or more offering apparatuses 3 subjected to removal score acquisition. If the score output instruction has no apparatus identifier, such a score output instruction is, for example, an instruction to output the removal scores of all the offering apparatuses 3 managed by the apparatus management unit 111.

A removal score is a score regarding the removal of an offering apparatus 3. The removal score may be considered to be information on the risk of removing the offering apparatus 3. The removal score may be considered to be information on the likelihood of removing the offering apparatus 3. The removal score may be considered to be information on the probability of removing the offering apparatus 3. Typically, the higher the removal score, the higher the risk of removing the offering apparatus 3. It is also possible that typically the higher the removal score, the lower the risk of removing the offering apparatus 3. It may be said that removing is to dismantle or withdraw.

The improvement output instruction is an instruction to output improvement information for one or two or more offering apparatuses 3. The improvement output instruction has, for example, one or two or ore app ratus identifiers. If the improvement output instruction has no apparatus identifier such an improvement output instruction is, for example, an instruction to output improvement information for all the offering apparatus 8 managed by the apparatus management unit 111. It is preferable that the improvement information is not output for the offering apparatus 3 that does not need to be improved.

The processing unit 13 performs various types of processing. The various types of processing are, for example, processing that is performed by the attribute value acquisition unit 131, the score acquisition unit 132, or the improvement acquisition unit 133.

If the acceptance unit 12 accepts one or more attribute values, the processing unit 13 accumulates the one or more attribute values in association with the apparatus identifier, in the apparatus management unit 111.

The attribute value acquisition unit 131 acquires one or two or more attribute values of the offering apparatus 3. The attribute value acquisition unit 131 typically acquires one or more attribute values of the offering apparatus 3 from the apparatus management unit 111. The attribute value acquisition unit 131 acquires, for example, one or more attribute values of each of the one or more offering apparatuses 3 corresponding to the score output instruction accepted by the acceptance unit 12. The attribute value acquisition unit 131 acquires, for example, one or more attribute values of each of the one or more offering apparatuses corresponding to the improvement output instruction accepted by the acceptance unit 12.

The score acquisition unit 132 acquires the removal score of the offering apparatus 3. The score acquisition unit 132 acquires the removal score acquired using the one or more attribute values of the offering apparatus 3.

The score acquisition unit 132 typically acquires the removal score using the one or more attribute values acquired by the attribute value acquisition unit 131. Note that the score acquisition unit 132 may read a removal score acquired by an unshown score acquisition part and stored in the storage unit II. The unshown score acquisition part is included in an unshown apparatus.

If the score acquisition unit 132 acquires the removal score by itself using the one or more attribute values, for example, any one of the following methods (1) to (3) may be adopted.

### (1) Case of Using Machine Learning

In the case of using machine learning, the score acquisition unit 132 includes the score model acquisition part 1322 and the score acquisition part 1323.

### (1-1) Case of Using Score Learning Model for Outputting Removal Score

The score model acquisition part 1322 acquires a score learning model in the storage unit 11. Next, the score acquisition part 1323 in this example acquires one or two or more attribute values of the offering apparatus 3 subjected to removal score acquisition. Next, the score acquisition part 1323 acquires the removal score, by performing prediction processing of machine learning using the One or more attribute values and the score learning model.

The score learning model is a model acquired by the learning apparatus 4, which will be described later. For example, the learning apparatus 4 acquires the score learning model, by performing learning processing of machine learning using two or more pieces of training data each having one or more attribute values of an offering apparatus 3 and a removal score. The score learning model is a model for outputting the removal score. The learning model may also be said to be a learner, a classifier a classification model, or the like.

### (1-2) Case of Using Score Learning Model for Outputting Prediction Result Indicating Whether or Not to Make Removal and Prediction Score

The score model acquisition part 1322 acquires a score learning model in the storage unit 11. Next, the score acquisition part 1323 in this example acquires one or two or more attribute values of the offering apparatus 3 subjected to removal score acquisition. Next, the score acquisition part 1323 acquires a prediction result and a prediction score, by performing prediction processing of machine learning using the me or more attribute values and the score learning model. Next, for example, if the prediction result is “will be removed”, the acquisition part 1323 acquires the prediction score as a removal score, or acquires a removal score using an increasing function in which the prediction score is taken as a parameter.

The score learning model in this example is a model acquired by the learning apparatus 4, which will be described later. For example, the learning apparatus 4 acquires the score learning model, by performing learning processing of machine learning using two or more pieces of training data each having one or two or more attribute values of an offering apparatus 3 and a removal flag indicating whether not the removal has been made. This score learning model is a model for outputting a prediction result indicating whether or not the offering ratus 3 will be removed in the future (e.g., “1” corresponding to “will be removed” and “0” corresponding to “will not be removed”) and a score.

Any machine learning algorithm can be used in this specification, such as deep learning, random forest, decision tree, SVR, SVM, or the like. For machine learning, for example, various machine learning functions such as the TensorFlow (registered trademark) library, the random forest module of the R language, fast Text, TinySVM, and various other existing libraries can be used.

### (2) Case of Using Correspondence Table

In the case of using a correspondence table, the score acquisition unit 132 includes the vector acquisition part 1321 and the score acquisition part 1323.

The vector acquisition part 1321 acquires one or more attribute values of the offering apparatus 3 subjected to removal score acquisition. Next, the vector acquisition part 1321 configures a vector using the one or more attribute values.

Next, for example, the score acquisition part 1323 in this example acquires a removal score paired with a vector that is most similar to the vector, from the correspondence table. For example, the ore acquisition part 1323 acquires removal score respectively paired with one or more vector whose similarity to the vector is greater than or equal to a threshold value or is greater than a threshold value, from the correspondence table, and acquires a representative value (e.g., an average value, a median value) of the one or more removal scores, as the removal score to be output. In this case, the correspondence table is a table having two or more pieces of correspondence information each having a vector based on one or more attribute values and a removal score.

For example, the score Acquisition part 1323 may acquire removal flags respectively paired with one or more vectors whose similarity to the vector is greater than or equal to a threshold value or is great than a threshold value, from the correspondence table, and calculate a removal score using the one or more removal flags. A removal flag is information indicating whether or not the removal has been made. The larger the number of removal flags indicating that the removal has been made, the higher the removal score acquired by the score acquisition part 1323. The score acquisition part 1323 acquires, for example, “number of removal flags indicating that removal has been made/number of removal flags acquired from correspondence table” as the removal score. In this case, the correspondence table is a table having two or more pieces of correspondence information each having a vector based on one or more attribute values and a removal flag.

### (3) Case of Using Operation Expression

In the case of using an operation expression core acquisition unit 132 includes the score acquisition part 1323.

The score acquisition part 1323 in this example acquires one or more attribute values of the offering apparatus 3 subjected to removal score acquisition. Next, the score acquisition part 1323 calculates a removal score, by substituting each of the one or more attribute values or information acquired from the attribute values for an operation expression in the storage unit 11, and executing the operation expression. The operation expression is, for example, an increasing function in which the number of visits, the number of inquiries, the number of product changes, the number of setting changes, sell-out time. operation period information, or power consumption is taken as a parameter. The operation expression is, for example, a decreasing function in which sales-related information, a contract duration, a remaining contract period, year, the number of products that can be offered, or the quantity of products that can be sold is taken as parameter. The operation expression is, for example, an expression that calculates a higher removal score when there is no cashless purchase method compared with when there is. The operation expression is, for example, an expression that calculates a higher removal score when there is no specific feature compared with when there is.

The improvement acquisition unit 133 acquires the improvement information, using the one or more attribute values acquired by the attribute value acquisition unit 131. The using the one or more attribute values acquired by the attribute value acquisition unit 131 includes being based on a removal score acquired using the one or more attribute values.

The improvement acquisition unit 133 acquires the improvement information, for example, based on the removal score. It is preferable that the improvement acquisition unit 133 acquires the improvement information, for example, only in a case in which the removal score is greater than or equal to a threshold value or is greater than a threshold value.

The method by which the improvement acquisition unit 133 acquires the improvement information is, for example, either one of the following methods (1) and (2).

### (1) Case of Using Machine Learning

In this case, the improvement acquisition unit 133 includes the improvement model acquisition part 1331 and the improvement prediction part 1332.

If the improvement acquisition unit 133 uses machine learning, either one of the following methods (1-1) and (1-2) may be adopted.

### (1-1) Case of Using One Learning Model

The improvement model acquisition part 1331 acquires an improvement learning model in the storage unit 11.

The improvement learning model in this example is a model acquired by the learning apparatus 4, which will be described later. The learning apparatus 4 acquires, for example, an improvement learning model through learning processing of machine learning using two more pieces of training data each having one or more attribute values of an offering apparatus 3 and an improvement information identifier. The improvement information identifier in this example is n identifier of improvement information in the case in which implementing improvement indicated by improvement information was effective (typically, the apparatus was not removed).

Next, the improvement prediction part 1332 acquires an improvement information identifier by performing prediction processing of machine learning using the one or more attribute values acquired by the attribute value acquisition unit 131 and the improvement learning model.

Next, the improvement acquisition part 1335 acquires improvement information identified with the acquired improvement information identifier, from the improvement management unit 113.

### (1-2) Case of Using Learning Models Respectively for Two or More Pieces of Improvement Information

The improvement model acquisition part 1331 acquires improvement learning models respectively for two or more pieces of improvement information, from the storage unit 11. The two or more improvement learning models are respectively associated with the improvement information identifiers.

Next, the improvement prediction part 1332 acquires, for each of the two or more pieces of improvement information, a prediction result by performing prediction processing of machine learning using an improvement learning model. paired with an improvement information identifier of improvement information of interest and the one or more attribute values acquired by the attribute value acquisition unit 131. The prediction result is “1” corresponding to “will be improved” or “0” corresponding to “will not be improved”, and a prediction score, which is a score of prediction processing.

Next, the improvement acquisition part 1335 acquires one or more piece of improvement information, using the prediction result acquired by the improvement prediction part 1332. The improvement acquisition part 1336 acquires, for example, one or more improvement information identifiers corresponding to the prediction result “will be improved “1”” acquired by the improvement prediction part 1332 and the prediction score satisfying a selection condition, and acquires pieces of improvement information respectively identified with the one or more improvement information identifiers. The selection. condition is, for example, that the prediction score is the highest, that the prediction score is greater than or equal to a threshold value or is greater than a threshold value, or that the prediction score is within the above N (N is a natural number of 2 or more).

The improvement learning model for each piece of improvement information is, for example, a model acquired by the learning apparatus 4, which will be described later. The learning apparatus 4 acquires, for example, an improvement learning model through learning processing of machine learning using two or more pieces of training data each having one or more attribute values of an offering apparatus 3 and result information regarding removal obtained by implementing improvement specified with the corresponding improvement information. The result information is, for example, “1” corresponding to “has been improved” or “0” corresponding to “has not been improved”.

The improvement learning model for each piece of improvement information is, for example, a model acquired by the learning apparatus 4, which will be described later. The learning apparatus 4 acquires, for example, an improvement learning model through learning processing of machine learning using two or more pieces of training data each having one or more positive examples having one or more attribute values of an offering apparatus 3 and one or more negative examples having one or more attribute values of an offering apparatus 3. A positive example is training data having one or two or more attribute values in the case in which improvement has been achieved in results regarding the removal obtained by implementing imp movement specified with the corresponding improvement information. A negative example is training data having one or two or more attribute values in the case in which improvement has not been achieved in results regarding the removal obtained by implementing improvement specified with the corresponding improvement information.

### (2) Case of Using Standard Attribute Value

The standard acquisition part 1383 acquires standard attribute values respectively for one or more attributes, from the standard management unit 112.

Next, the attribute determination part 1334 respectively compares, for the one or more attributes of the offering apparatus 3, the attribute values acquired by the attribute value acquisition unit 131 and the stand attribute values acquired by the standard acquisition part 1333, and determines defectiveness attributes. For example, the attribute determination part 1334 respectively compares, for the one or more attributes of the offering apparatus 3, the attribute values acquired by the attribute value acquisition unit 131 and the standard attribute values, and acquires attribute identifiers for respectively specifying one or more defectiveness attributes.

A defectiveness attribute is an attribute with an attribute value that is not good compared with the standard attribute value. The defectiveness attribute is an attribute satisfying a defectiveness condition. The defectiveness condition is, for example, “attribute values acquired by attribute value acquisition unit 131<standard attribute value” or “attribute value acquired by attribute value acquisition unit 131—standard attribute value≥threshold value”. The defectiveness condition may be different for each attribute or common to all attributes.

Next, the improvement acquisition part 1335 acquires pieces of improvement information respectively corresponding to the one or more defectiveness attributes determined by the attribute determination part 1334; from the improvement management unit 113. The improvement acquisition part 1335 acquires pieces of improvement information respectively paired with attribute identifiers of the one or more defectiveness attributes acquired by the attribute determination part 1334, from the improvement management unit 113.

The output unit 14 outputs various types of information. The various types of information are, for example, removal scores or improvement information.

The term “output” in this case is typically transmission to the terminal apparatus 2, but may be a concept that encompasses display on a display screen, projection using a projector, printing by a printer, transmission to another external apparatus, accumulation in a recording medium, and delivery of a processing result to another processing apparatus or another program.

The score output unit 141 outputs the removal score acquired by the score acquisition unit 132. The score output unit 141 outputs, for example, the removal scores respectively for two or more offering apparatuses 3. The score output unit 141 outputs the removal scores, for example, respectively in association with apparatus identifiers of the two or more offering apparatuses 3.

The improvement output unit 142 outputs the improvement information acquired by the improvement acquisition unit 133. The improvement output unit 142 outputs, for example, the pieces of improvement information respectively for two or more offering apparatuses 3. The improvement output unit 142 outputs the pieces of improvement information, for example, respectively in association with apparatus identifiers of the two or more offering apparatuses 3.

The terminal apparatus 2 accepts a score output instruction from the user, and transmits the score output instruction to the information processing apparatus 1. Then, the terminal apparatus 2 receive a removal score from the information processing apparatus 1 in response to the transmission of the score output instruction, and outputs the removal score.

The terminal apparatus 2 accepts an improvement output instruction from the user, and transmits the improvement output instruction to the information processing apparatus 1. Then, the terminal apparatus 2 receives improvement information from the information processing apparatus 1 in response to the transmission of the improvement of put instruction, and outputs the improvement information.

The terminal apparatus 2 accepts on e or more attribute values associated with an apparatus identifier from the user, and transmits the one or more attribute values in association with the apparatus identifier, to the information processing apparatus 1. Accordingly, the one or more attribute values of the offering apparatus 3 identified with the apparatus identifier are accumulated in the apparatus management unit 111.

For example, in response to the sale of an article, the offering apparatus 3 transmits one or more attribute values containing sales-related information, in association with the apparatus identifier to the information processing apparatus 1. There is no limitation on the time to transmit the sales related information. Accordingly, the one or more attribute values containing sales related information of the offering apparatus 3 identified with the apparatus identifier are registered in the apparatus management unit 111.

Various types of information are stored in a learning storage unit 41 constituting the learning apparatus 4. The various types of information are, for example, two or more pieces of score training data or two or more pieces of improvement training data.

The score training data is training data for building a score learning model for outputting the removal score. A first example of the score training data has one or two or more attribute values of an offering apparatus 3 and a removal score. A second example of the score training data has one or two or 15. more attribute values of an offering apparatus 3 and a removal flag The removal flag is information indicating whether or not an offering apparatus 3 has been removed.

The improvement training data is training data for building an improvement learning model for acquiring the improvement information. A first example of the improvement training data has one or two or more attribute values of an offering apparatus 3 and an improvement information identifier, The improvement information identifier in the first example of the improvement training data is an identifier of improvement information with which improvement has been achieved through implementation.

A second example of the improvement training data is training data associated with an improvement information identifier, and has one or two or more attribute values of an offering apparatus 3 and an improvement flag. The improvement flag is information indicating whether or not improvement has been achieved in the case in which improvement specified with the improvement information identified with the improvement information identifier is implemented.

A score learning part 421 acquires a score learning model by performing learning processing of machine learning using two or more pieces of score training data, and accumulates the score learning model. The score learning model is accumulated in, for example, the storage unit 11 of the information proc sing apparatus 1, but there is no limitation to this.

An improvement learning part 422 acquires an improvement learning model by performing learning processing of machine learning using two or more pieces of improvement training data, and accumulates the improvement learning model. For example, the improvement learning part 422 acquires, for each of two or more improvement information identifiers, an improvement learning model by performing learning proc sing of machine learning using two or more pieces of improvement training data paired with an improvement information identifier, and accumulates the improvement learning model in a pair with the improvement information identifier. The improvement learning model is accumulated in, for example, the storage unit 11 of the information processing apparatus 1, but there is no limitation to this.

The storage unit 11, the apparatus management unit 111, the standard management unit 112, and the learning storage unit 41 are preferably non-volatile recording media, but they may alternately be realized by volatile recording media.

There is no limitation on the procedure in which information is stored in the storage unit 11. For example, information may be stored in the storage unit 11 via a recording medium, information transmitted via a communication line or the like may be stored in the storage unit 11, or information input via an input device may be stored in the storage unit 11.

The acceptance unit 12 is typically realized by a wireless or wired communication part, but it may also be realized by a broadcast receiving part. The acceptance unit 12 may be realized by a device driver for an input part such as a touch screen or a keyboard, control software for a menu screen, or the like.

The processing unit 13, the attribute value acquisition unit 131, the score acquisition unit 132, the improvement acquisition unit 138, the vector acquisition part 1321, the score model acquisition part 1322, the score acquisition part 1323, the improvement model acquisition part 1331, the improvement prediction part 1332, the standard acquisition part 1333, the attribute determination part 1334, the improvement acquisition part 1335, a learning processing unit 42, the score learning part 421, and the improvement learning part 422 may be typically realized by processor memories, or the like. Typically, the processing procedure of the processing unit 13 and the like is realized by software, and the software is stored in a recording medium such as a ROM. However, the processing procedure may be realized by hardware (dedicated circuits). The processors are, for example, CPUs, MPUs, GPUs, or the like, but there is no limitation on the type thereof.

The output unit 14, the score output unit 141, and the improvement output unit 142 are typically realized by wireless or wired communication parts, but they may also be realized by broadcasting parts. The output unit 14 and the like may be realized by a combination of driver software for an output device such as a display screen or speaker and the output device, or the like.

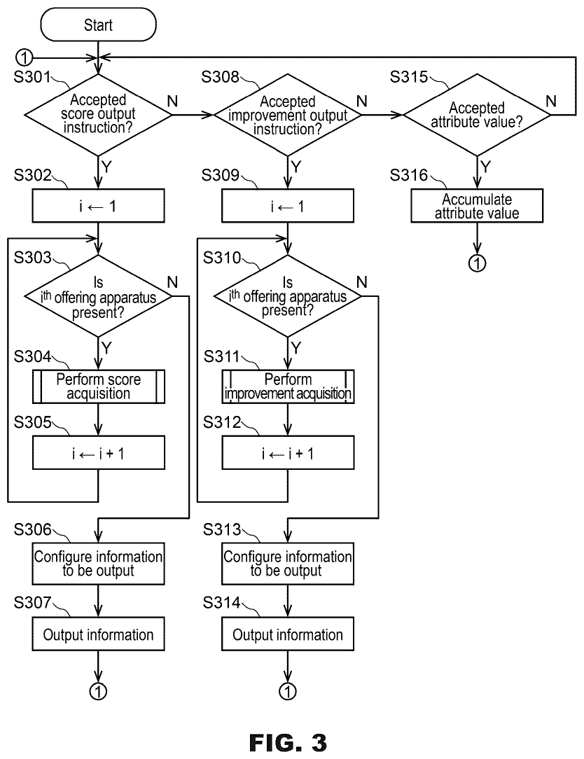

Next, an operation example of the information processing apparatus 1 will be described with reference to the flowchart in FIG. 3.

(Step S301) The acceptance unit 12 determines whether or not it has accepted a score output instruction. If it has accepted a score output instruction, the procedure advances to step S302, or otherwise the procedure advances to st S308. In this step, the acceptance unit 12 typically re output instruction from a terminal apparatus 2.

(Step S302) The processing unit 13 substitutes 1 for a counter i.

(Step S803) The processing unit 13 determines whether or not an i^{th} offering apparatus 3 corresponding to the score output instruction is present. If such an i^{th} offering apparatus 3 is present, the procedure advances to step S304, or otherwise the procedure advances to step S306.

(Step S304) The score acquisition unit 132 and the like perform processing for acquiring a removal score of the i^{th} offering apparatus 3. An example of this score acquisition processing will be described later with reference to the flowcharts in FIGS, 4 and 5.

(Step S305) The processing unit 13 increments the counter i by 1. The procedure returns to step S803.

(Step S306) The score acquisition unit 132 configures information that is to be output, which is information containing the one or more removal scores acquired in step S304. The information that is to be output has, for example, pairs of the apparatus identifiers of offering apparatuses 3 and the removal scores.

(Step S307) The score output unit 141 outputs the information configured in step S306. In this step, the score output unit 141 typically transmits the information to the terminal apparatus 2 from which the score output instruction was transmitted.

(Step S308) The acceptance unit 12 determines whether or not it has accepted an improvement output instruction. If it has accepted an improvement output instruction, the procedure advances to step S309, or otherwise the procedure advances to step S315. In this stop, the acceptance unit 12 typically receives an improvement output instruction from a terminal apparatus 2.

(Step S309) The processing unit 13 substitutes 1 for a counter i.

(Step S310) The processing unit 13 determines whether or not an i^{th} offering apparatus 3 corresponding to the improvement output instruction is present. If such an i^{th} offering apparatus 3 is present, the procedure advances to step S311, or otherwise the procedure advances to step S313.

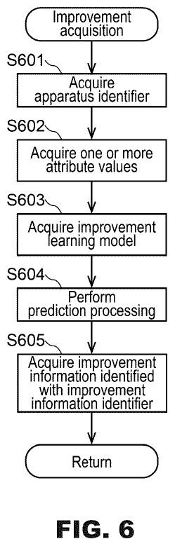

(Step S311) The improvement acquisition unit 133 and the like perform processing for acquiring improvement information for the i^{th} offering apparatus 3. An example of this improvement acquisition processing will be described with reference to the flowcharts in FIGS. 6, 7, and 8.

(Step S312) The processing unit 13 increments the counter i by 1. The procedure returns to step S310.

(Step S313) The improvement acquisition unit 133 configures information that is to be output, which is information containing the one or more pieces of improvement information acquired in step S311. The information that is to be output has, for example, pairs of the apparatus identifiers of offering apparatuses 3 and the improvement information.

(Step S314) The improvement output unit 142 outputs the information configured in step S313. In this step, the improvement output unit 142 typically transmits the information to the terminal apparatus 2 from which the improvement output instruction was transmitted.

(Step S315) The acceptance unit 12 determines whether or not it has accepted one or more attribute values in association with an apparatus identifier. If it has accepted one or more attribute values, the procedure advances to step S316, or otherwise the procedure re to step S301. In this step, the acceptance unit 12 typically receives one or more attribute values from a terminal apparatus 2 or an offering apparatus 3.

(Step S316) The processing unit 13 accumulates the one or more attribute values accepted in step S315, in association with the apparatus identifier, in the apparatus management unit 111.

In the flowchart in FIG. 3, the processing ends at power off or at an interruption of terminating processing.

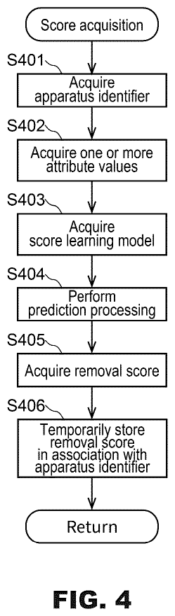

Next, a first example of the score acquisition processing step S304 will be described with reference to the flowchart in FIG. 4. The first example of the score acquisition processing corresponds to a case in which machine learning is used.

(Step S401) The attribute value acquisition unit 131 acquires an apparatus identifier of the offering apparatus subjected to removal score acquisition. The apparatus identifier is contained in, for example, the score output instruction.

(Step S402) The attribute value acquisition unit 131 acquires one or two or more attribute values each paired with the apparatus identifier acquired in step S401, from the apparatus management unit 111.

(Step S403) The se re mod el acquisition part 1322 quires a score learning model from the storage unit 11.

(Step S404) The vector acquisition part 1321 configures a vector using the one or more attribute values acquired in step S402. The score acquisition part 1323 gives the vector and the score learning model to a prediction module for performing prediction processing of machine learning, and executes the prediction module, thereby acquiring a removal score.

(Step S405) The score acquisition part 1323 temporarily stores the removal score acquired in step S404 in an unshown buffer in association with the apparatus identifier acquired in step S401. The procedure returns to the upper level processing.

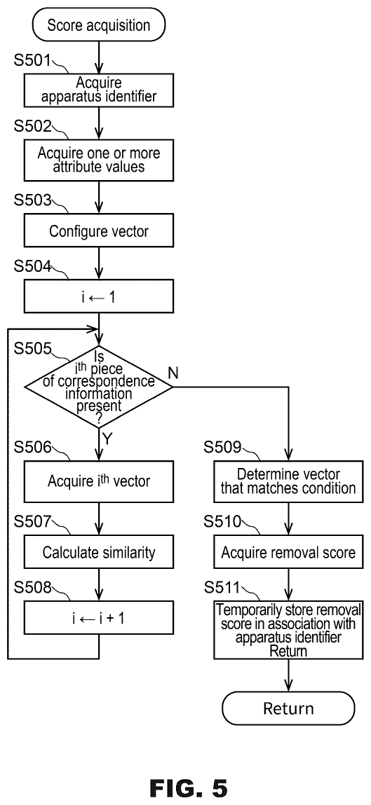

Next, a second example of the score acquisition processing in step S304 will be described with reference to the flowchart in FIG. 5. The second example of the score acquisition processing corresponds to a case in which a correspondence table is used.

(Step S501) The attribute value acquisition unit 131 acquires an apparatus identifier of the offering apparatus 3 subjected to removal score acquisition.

(Step S502) The attribute value acquisition unit 131 acquires one or two or more attribute values each paired with the apparatus identifier, from the apparatus management unit 111.

(Step S503) The vector acquisition part 1321 configures a vector using the one or more attribute values acquired in step S502.

(Step S504) The score acquisition part 1323 substitutes 1 for a counter i.

(Step S506) The score acquisition part 1323 determines whether or not an i^{th} piece of correspondence information is present in the correspondence table in the storage unit 11. If an i^{th} piece of correspondence information is present, the procedure advances to step S506, or otherwise the procedure advances to step S509.

(Step S506) The score acquisition part 1323 acquires a vector contained in the i^{th} piece of correspondence information from the correspondence table in the storage unit 11.

(Step S507) The score acquisition part 1323 calculates the similarity between the vector acquired in step S503 and the vector acquired in step S506. The score acquisition part 1323 temporarily stores the similarity in an unshown buffer in association with the i^{th} piece of correspondence information.

(Step S508) The score acquisition part 1323 increments the counter i by 1. The procedure returns to step S505.

(Step S509) The score acquisition part 1323 determines one or two or more similarities that match a condition, from among the similarities temporarily stored in the unshown buffer. Determining the similarity is to determine a vector The condition in this example is, for example, “being the largest”, “being greater than or equal to a threshold value or is greater than a threshold value”, or “being within the top N”.

(Step S510) The score acquisition part 1323 acquires removal scores respectively paired with the one or more vectors determined in step S509, from the correspondence table. In the case of acquiring two of more removal score from the correspondence table, for example, the score acquisition part 1323 acquires a representative value of the two or more removal is as the final removal score.

(Step S511) The score acquisition part 1323 temporarily stores the removal score acquired in step S510 in an unshown buffer in association with the apparatus identifier of the offering apparatus 3. The procedure returns to the upper level processing.

Next, a third example of the score acquisition processing, that is, a case in which an operation expression is used, will be described. The attribute value acquisition unit 131 acquires an apparatus identifier of the offering apparatus 3 subjected to removal score acquisition. Next, the attribute value acquisition unit 131 acquires one or two or more attribute values each paired with the apparatus identifier, from the apparatus management unit 111. Next, the score acquisition part 1323 acquires the removal score, by substituting each of the acquired one or more attribute values for an operation expression for calculating a removal score, and executing the operation expression. Next, the score acquisition part 1323 temporarily stores the removal score acquired in step S510 in an unshown buffer in association with the apparatus identifier of the offering apparatus 3.

Next, a first example of the improvement acquisition processing in step S311 will be described v reference to the flowchart in FIG. 6. The first example of the improvement acquisition processing corresponds to a case in which improvement information is acquired through prediction processing of machine learning using one improvement learning model.

(Step S601) The attribute value acquisition unit 131 acquires an apparatus identifier of the offering apparatus 3 subjected to removal score acquisition. The apparatus identifier is contained in, for example, the improvement output instruction.

(Step S602) The attribute value acquisition unit 131 acquires one or two or more attribute values each paired with the apparatus identifier acquired in step S601, from the apparatus management unit 111.

(Step S603) The improvement model acquisition part 1331 acquires an improvement learning model from the storage unit 11.

(Step S604) The improvement prediction part 1332 configures a vector using the one or more attribute values acquired in step S602. The improvement prediction part 1332 gives the vector and the improvement learning model to a prediction module for performing prediction processing of machine learning, and executes the prediction module, thereby acquiring an improvement information identifier.

(Step S605) The improvement acquisition part 1335 acquires improvement information paired with the improvement information identifier acquired in step S604, from the improvement management unit 113. The procedure returns to the upper-level processing.

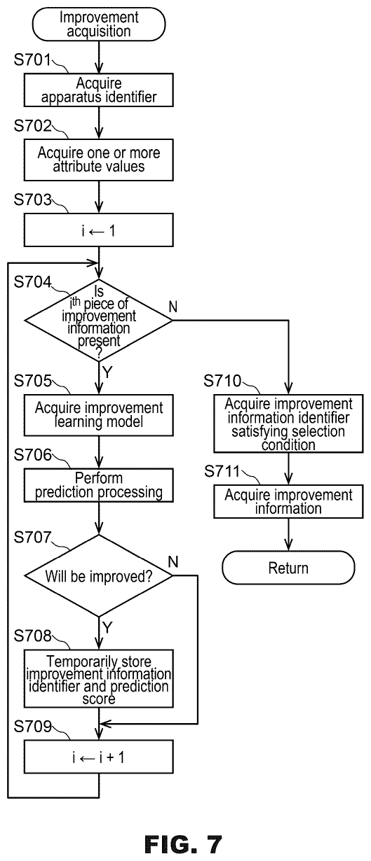

Next, a second example of the improvement acquisition processing in step S311 will be described with reference to the flowchart in FIG. 7. The second example of the improvement acquisition processing corresponds to a case in which improvement information is acquired through prediction processing of machine learning using an improvement learning model for each piece of improvement information.

(Step S701) The attribute value acquisition unit 131 acquires an apparatus identifier of the offering apparatus 3 subjected to removal score acquisition. (Step S702) The attribute value acquisition unit 131 acquires one or two or more attribute values each paired with the apparatus identifier acquired in step S701, from the apparatus management unit 111.

(Step S703) The improvement acquisition unit 133 substitutes 1 for a counter i.

(Step S704) The improvement acquisition unit 133 determines whether or not an i^{th} piece of improvement information is present in the improvement management unit 113. If an i^{th} piece of improvement information is present, the procedure advances to step S705, or otherwise the procedure advances to step S710. Determining whether or not an i^{th} piece of improvement information is present is the same as determining whether or not an i^{th} improvement information identifier is present.

(Step S706) The improvement model acquisition part 1331 acquires an improvement learning model paired with the its piece of improvement information. from the storage unit 11.

(Step S706) The improvement prediction part 1332 configures a vector using the one or more attribute values acquired in step S702. The improvement prediction part 1332 gives the vector and the improvement learning model acquired in step S705 to a prediction module for performing prediction processing of machine learning, and executes the prediction module, thereby acquiring a prediction result and a prediction score. The prediction result is “will be improved” (e.g., “1”) or “will not be improved” (e.g., “0”).

(Step S707) If the prediction result acquired in step S706 is “will be improved”, the improvement acquisition part 1335 advances the procedure to stop S708, or otherwise it advances the procedure to step S709.

(Step S708) The improvement acquisition part 1335 temporarily stores the improvement information identifier of the it piece of improvement information and the prediction score in association with each other in an unshown buffer.

(Step S709) The improvement acquisition unit 133 increments the counter i by 1, The procedure returns to step S704.

(Step S710) The improvement acquisition part 1335 acquires improvement information identifiers respectively paired with the one or more prediction scores satisfying a selection condition, from an unshown buffer The selection condition is, for example, that the prediction score is the highest, that the prediction score is greater than or equal to a threshold value or is greater than a threshold value, or that the prediction score is within the top N (N is a natural number of 2 or more).

(Step S711) The improvement acquisition part 1335 acquires pieces of improvement information respectively identified with the one or more improvement information identifiers acquired in step S710, from the improvement management unit 113. The procedure returns to the upper-level processing.

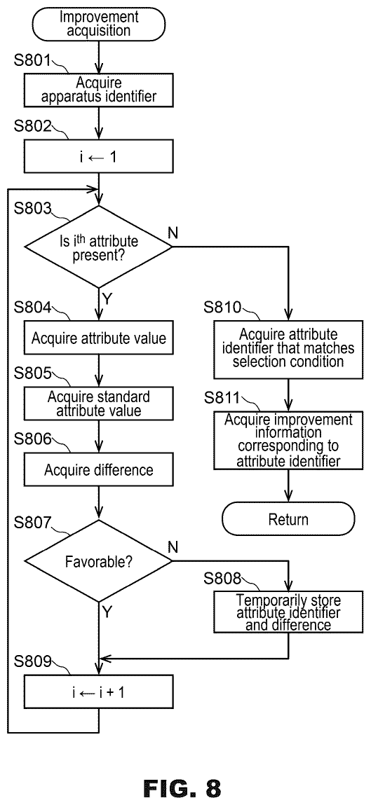

Next, a third example of the improvement acquisition processing in step S311 will be described with reference to the flowchart in FIG. 8. The third example of the improvement a acquisition processing corresponds to a case in which a standard attribute value is used.

(Step S801) The attribute value acquisition unit 131 acquires an apparatus identifier of the offering apparatus 3 subjected to removal score acquisition.

(Step S802) The attribute value acquisition unit 131 substitutes 1 for a counter i.

(Step S803) The attribute value acquisition unit 131 determines whether or not an i^{th} attribute of the offering apparatus 3 is present. If an i^{th} attribute is present, the procedure advances to step S804, or otherwise the procedure advances to step S810,

(Step S804) The attribute value acquisition unit 131 acquires an i^{th} attribute value paired with the apparatus identifier acquired in step S801, from the apparatus management unit 111.

(Step S805) The standard acquisition part 1333 acquires a standard attribute value corresponding to the i^{th} attribute, from the standard management unit 112.

(Step S806) The attribute determination part 1334 acquires a difference between the i^{th} attribute value and the i^{th} standard attribute value.

(Step S807) The attribute determination part 1334 determines whether or not the difference acquired in step S806 satisfies a favorability condition. If the difference satisfies a favorability condition, the procedure advances to step S809, or otherwise the procedure advances to step S808. The favorability condition is, for example, that the difference is less than or equal to a threshold value or is less than a threshold value.

The attribute determination part 1334 may use a defectiveness condition instead of the favorability condition. In this case, the attribute determination part 1334 determines whether or not the difference acquired in step S806 satisfies the defectiveness condition. If it satisfies the defectiveness condition, the procedure advances to step S808, or otherwise the procedure advances to step S80. The defectiveness condition is, for example, that the difference is greater than or equal to a threshold value or is greater than a threshold value.

(Step S808) The attribute determination part 1334 temporarily stores the attribute identifier for identifying the it attribute and the difference in association with each other in an unshown buffer.

(Step S809) The attribute value acquisition unit 131 increments the counter i by 1. The procedure returns to step S803.

(Step S810) The attribute determination part 1334 acquires an attribute identifier that matches a selection condition. The selection condition is, for example, that the difference is the largest or that the difference is within the top N (is a natural number of 2 or more) . The attribute determination part 1334 may acquire all attribute identifiers in the unshown buffer.

(Step S811) The improvement acquisition part 1335 acquires pieces of improvement information respectively paired with the one or more attribute identifiers acquired in step S810, from the improvement management unit 113 The procedure returns to the upper level processing.

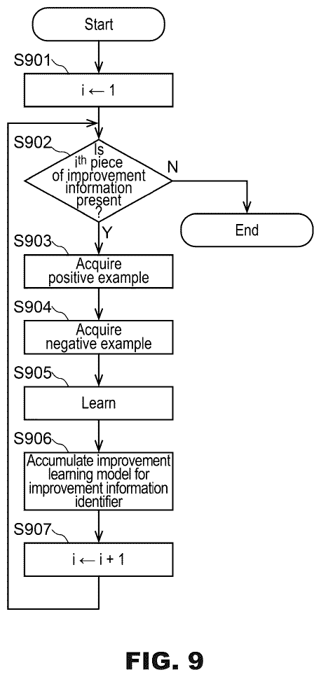

Next, an operation example of the learning apparatus 4 will be described with reference to the flowchart in FIG. 9. The operation example in this case corresponds to an example of an operation in which improvement learning models respectively for two or more pieces of improvement information are acquired.

(Step S901) The improvement part 422 substitutes 1 for a counter i.

(Step S902) The improvement learning part 422 determines whether or not an i^{th} piece of improvement information is present. If an i^{th} piece of improvement information is present, the procedure advances to step S903, or otherwise the processing is ended.

(Step S903) The improvement learning part 422 acquires one or more positive examples each paired with the improvement information identifier of the i^{th} piece of improvement information, from the learning storage unit 41. A positive example is information based on one or more tribute values of the offering apparatus 3 for which implementation of measures specified with the i^{th} piece of improvement information was effective (typically, the apparatus was not removed). This information is, for example, a vector in which the one or mor attribute values of the offering apparatus 3 are taken as elements.

(Step S904) The improvement learning part 422 acquires one or more negative examples each paired with the improvement information identifier of the i^{th} piece of improvement information, from the learning storage unit 41. A negative example is information based on one or more attribute values of the offering apparatus 3 for which implementation of measures specified with the i^{th} piece of improvement information was not effective (typically, the apparatus was removed). This information is for example, a vector in which the one or more attribute values of the offering apparatus 3 are taken as elements.

(Step S905) The improvement learning part 422 gives the one or more positive examples and the one or more negative examples to a learning module for performing learning processing of machine learning, and executes the learning module, thereby acquiring an improvement learning model for the i^{th} piece of improvement information.

(Step S906) The improvement learning part 422 accumulates the improvement learning model in a pair with the improvement information identifier of the i^{th} piece of improvement information.

(Step S907) The improvement learning part 422 increments the counter i by 1. The procedure returns to step S902.

Hereinafter, a specific operation of the information system A in this embodiment will be described. The conceptual diagram of the information system A is shown in FIG. 1.

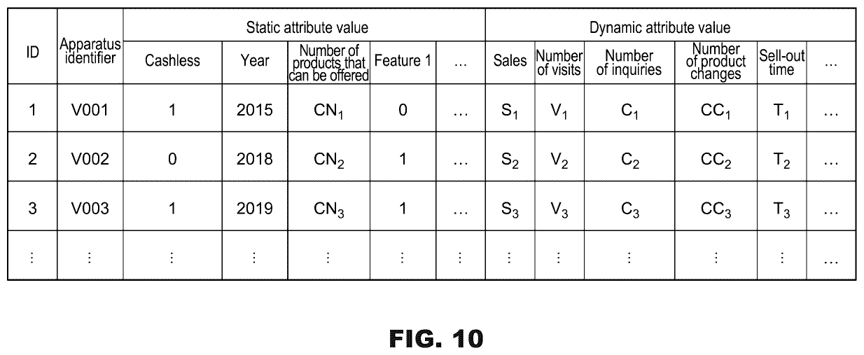

It is assumed that the apparatus management table shown in FIG. 10 is stored in the apparatus management unit 111 of the information processing apparatus 1. The apparatus management table is a table for managing offering apparatuses 3. It is assumed th t the offering apparatuses 3 in this example are vending machines. The apparatus management table manages one or more records each having “ID”, “apparatus identifier”, “static attribute value”, and “dynamic attribute value”, “Static attribute value” has “cashless”, “year” “number of products that can be offered”, and “feature 1”. “Dynamic attribute value” has “sales”, “number of visits”, “number of inquiries”, “number of product changes”, and “sell-out time”. “Cashless” is information indicating whether or not the vending machine has a cashless purchase method. If the vending machine has a cashless purchase method, the attribute value of “cashless” is “1”, or otherwise the attribute value is “0”. “Year” indicates the year when the vending machine was manufactured. “Number of products that can be offered” is for example, the number of columns in the vending machine. “Feature” information indicating whether or not the vending machine has the feature. If the vending machine has the feature, the attribute value is “1”, or otherwise the attribute value is “0”. It is assumed that the symbols for the attribute values (e.g., “CN₁”, “S₁”, “V₁”, “C₁”, “CC₁”, “T₁”) in the apparatus management table are numeric values.

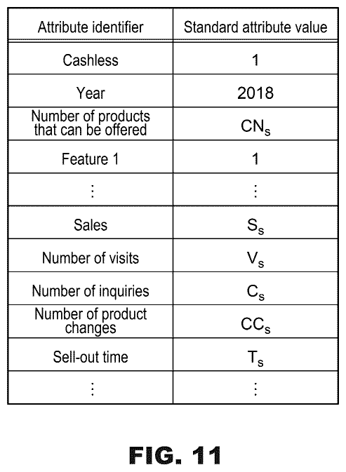

The standard management table shown in FIG. 11 is stored in the standard management unit 112. The standard management table is a table for managing standard attribute values respectively for attributes. The standard management table manages one or more records each having “attribute identifier” and “standard attribute value”. It is assumed that the symbols for “standard attribute value” (e.g., “CN_{S}”, “Sₛ”, “Vₛ”, “Cₛ”, “CCₛ”, “Tₛ”) are numeric values.

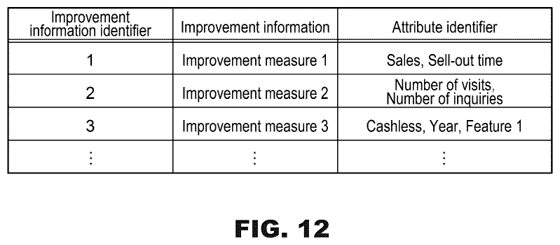

The improvement management table shown in FIG. 12 is stored in the improvement management unit 113. The improvement management table is a table for managing improvement information. The improvement management table manages one or more records each having “improvement information identifier”, “improvement information”, and “attribute identifier”. It is assumed that the improvement information “improvement measure 1” is information indicating a specific improvement measure. “Attribute identifier” indicates that the improvement measure indicated by the improvement information paired therewith is selected in the case in which the attribute value identified with the attribute identifier satisfies a defectiveness condition.

The following seven specific examples in this case will be described. Specific Example 1 corresponds to a case in which a score learning model for acquiring a removal score is acquired. Specific Example 2 corresponds to a case in which one improvement learning model for acquiring improvement information is acquired. Specific Example 3 corresponds to a case in improvement learning models respectively for two or more pieces of improvement information are acquired. Specific Example 4 corresponds to a case in which a removal score is acquired. Specific Example 5 corresponds to a case in which improvement information is acquired using the improvement learning model generated in Specific Example 2. Specific Example 6 corresponds to a case in which improvement information is acquired using the improvement learning models generated in Specific Example 3. Specific Example 7 corresponds to a case in which improvement information is acquired using standard attribute values.

### Specific Example 1

It is assumed that two or more pieces of training data for building a score learning model are stored in the learning storage unit 41 of the learning apparatus 4. The training data has the structure (cashless or not, year, number of products that can be offered, presence or absence of feature 1, . . . , sales, number of visits, number of inquiries, number of product changes, sell out time, . . . , removal score). That is to say the training data has explanatory variables (cashless or not, year, number of products that can be offered, presence or absence of feature 1, . . . , sales, number of visits, number of inquiries, number of product changes, sell-out time, . . . , and an objective variable (removal score). The explanatory variables are attribute values of the vending machine. It is assumed that the removal score is, for example, the percentage (probability) of vending machines with the same set of attribute values that have been removed in the past. Note that the removal score may also be a manually entered numeric value.

Then, the score learning part 421 reads two or more pieces of training data from the learning storage unit 41, gives the two or more pieces of training data to a learning module, and executes the learning module. As a result, the score learning part 421 acquires and accumulates a score learning model in the storage unit 11 of the information processing apparatus 1.

### Specific Example 2

It is assumed that two or more pieces of training data for building an improvement learning model are stored in the learning storage unit 41 of the learning apparatus 4. The training data has the structure (cashless or not, year, number of products that can be offered, presence or absence of feature 1, . . . , sales, number of visits, number of inquiries, number of product changes, sell-out time, . . . , improvement information identifier of improvement plan that was effective). That is to say, the training data has explanatory variables (cashless or not, year, number of products that can be offered, presence of feature 1, . . . , sales, number of visits, number of inquiries, number of product changes, sell-out time, . . . ) and an objective variable (improvement information identifier of improvement plan that was effective).

Then, the improvement learning part 422 reads two or more pieces of training data from the learning storage unit 41, gives the two or more pieces of training data to a learning module, and executes the learning module, As a result, the improvement learning part 422 acquires one improvement learning model. Next, the improvement learning part 422 accumulates the acquired improvement learning model in the storage unit 41 of the information processing apparatus 1.

### Specific Example 3

It is assumed that two or more pieces of training data for building an improvement learning model are stored in the learning storage unit 41 of the learning apparatus 4, in association with each of two or more improvement information identifiers. For each of the improvement information identifiers, one or more positive examples and one or more negative examples are stored in the learning storage unit 41. A positive example is training data having a set of attribute values of vending machines for which implementation of the measure indicated by the improvement information identified with the corresponding improvement information identifier was effective. A negative examples is training data having a set of attribute values of vending machines for which implementation of the measure indicated by the improvement information identified with the corresponding improvement information identifier was not effective. The training data has the structure (cashless or not, year, number of products that can be offered, presence or absence of feature 1, . . . , sales, number of visits, number of inquiries, number of product changes, sell-out time, . . . ).

Then, for each of the two or more improvement information identifiers, the improvement learning part 422 reads two or more pieces of training data (including positive and negative examples) paired with the improvement information identifier from the learning storage unit 41, gives the two or more pieces of training data to a learning module, and executes the learning module. As a result, the improvement learning part 422 acquires improvement learning models respectively for the two or more improvement information identifiers. Next, the improvement learning part 422 accumulates the acquired improvement learning models in the storage unit 11 of the information processing apparatus I respectively in association with the two or more improvement information identifiers.

### Specific Example 4

The terminal apparatus 2 output instruction from the user, and transmits the score output instruction to the information processing apparatus 1. It is assumed that the score output instruction is an instruction to output removal scores of all vending machines managed by the apparatus management table (FIG. 10).

The acceptance unit 12 of the information processing apparatus 1 receives the score output instruction from the terminal apparatus 2. Next, the attribute value acquisition unit 131 refers to the apparatus management table (FIG. 10), and acquires static and dynamic attribute values from the record “ID=1” and the following records sequentially. Next, the vector acquisition part 1321 configures, for each record, a vector in which the acquired attribute values are taken as elements. Next, the score model acquisition part 1322 acquires a score learning model from the storage unit 11. Next, for each record, the score acquisition part 1323 gives the vector configured by the vector acquisition part 1321 and the score learning model to a prediction module for performing prediction processing of machine learning, and executes the prediction module, thereby acquiring a removal score. Next, the score acquisition part 1323 accumulates, for each record, the acquired removal score in the apparatus management unit 111, in association with the apparatus identifier contained in the record.

Furthermore, the score output unit 141 transmits the removal scores respectively paired with the two or more apparatus identifiers, to the terminal apparatus 2.

Next, the terminal apparatus 2 receives and outputs the removal scores respectively paired with the two or more apparatus identifiers. There is no limitation on the manner in which the removal scores are output.

### Specific Example 5

The terminal apparatus 2 accepts an improvement output instruction having the apparatus identifier “V001” from the user, and transmits the improvement output instruction to the information processing apparatus 1. It is assumed that the improvement output instruction in this example is an instruction to output improvement information of a specific vending machine.

The acceptance unit 12 of the information processing apparatus 1 receives the improvement output instruction from the terminal apparatus 2. Next, the attribute value acquisition unit 131 refers to the apparatus management table (FIG. 10), and acquires static and dynamic attribute values from the record “ID=1” containing the apparatus identifier “V001”. Next, the improvement prediction part 1332 configures a vector (1, 2015, CN₁, 0, . . . , S₁, V₁, C₁, CC₁, T₁, . . . ) in which the acquired attribute values taken as elements. Next, the improvement model acquisition part 1331 acquires the improvement learning model generated in Specific Example 2, from the storage unit 11. Next, it is assumed that the improvement prediction part 1332 gives the vector and the improvement learning model to a prediction module for performing prediction processing of machine learning, and executes the prediction module, thereby acquiring an improvement information identifier “2”. Next, the improves acquisition part 1335 acquires improvement information “improvement measure 2” paired with the improvement information identifier “2”, from the improvement management table (FIG. 12). Next, the improvement output unit 142 transmits the improvement information “improvement measure 2” to the terminal apparatus 2.

Next, the terminal apparatus 2 receives and outputs the improvement information “improvement measure 2”. There is no limitation on the manner in which the improvement information is output.

### Specific Example 6

The terminal apparatus 2 accepts an improvement output instruction having the apparatus identifier “V001” from the user, and transmits the improvement output instruction to the information process apparatus 1. It is assumed that the improvement output instruction in this example is an instruction to output improvement information of a specific vending machine.

The acceptance unit 12 of the information processing apparatus 1 receives the improvement output instruction from the terminal apparatus 2. Next, the attribute value acquisition unit 131 refers to the apparatus management table (FIG. 10), and acquires static and dynamic attribute values from the record “ID=1” containing the apparatus identifier “V001”. Next, the improvement prediction part 1332 configures a vector (1, 2015, CN₁, 0, . . . , S₁, V₁, C₁, CC₁, T₁, . . . ) in which the acquired attribute values are taken as elements.

Next, the improvement model acquisition part 1331 acquires, for each of the two or more improvement information identifiers, the improvement learning model generated in Specific Example 3 and paired with the improvement information identifier from the storage unit 11.

Next, for each of the two or more improvement information identifiers, the improvement prediction part 1332 gives the vector (1, 2015, CN₁, 0, . . . , S₁, V₁, C₁, CC₁, T₁, . . . ) and the improvement learning model to a prediction module for performing prediction processing of machine learning, and executes the prediction module, thereby acquiring a prediction result indicating whether or not improvement will be achieved, and a score.

Next, it is assumed that the improvement acquisition part 1336 acquires an improvement information identifier “2” with the prediction result “1” indicating that improvement will be achieved and the largest score. Next, the improvement acquisition part 1335 acquires improvement information “improvement measure 2” paired with the improvement information identifier “2”. from the improvement management table (FIG. 12). Next, the improvement output unit 142 transmits the improvement information “improvement measure 2” to the terminal apparatus 2.

Next, the terminal apparatus 2 receives and outputs the improvement information “improvement measure 2”.

### Specific Example 7

The terminal apparatus 2 accepts an improvement output instruction having the apparatus identifier “V001” from the user, and transmits the improvement output instruction to the information processing apparatus 1. It is assumed that the improvement output instruction in this example is an instruction to output improvement information of a specific vending machine.

The acceptance unit 12 of the information processing apparatus 1 receives the improvement output instruction from the terminal apparatus 2. Next, the attribute value acquisition unit 131 refers to the apparatus management table (FIG. 10), and acquires static and dynamic attribute values from the record “ID=1” containing the apparatus identifier “V001”. Next, the improvement prediction part 1332 configures a vector (1, 2010, CN₁, 0, . . . , S₁, V₁, C₁, CC₁, T₁, . . . ) in which the acquired attribute values are taken as elements.

Furthermore, the standard acquisition part 1333 acquires a set of standard attribute values (1, 2018, CNₛ, 0, . . . , Sₛ, Vₛ, Cₛ, CCₛ, Tₛ, . . . ) from the standard management table (FIG. 11).

Next, the attribute determination part 1334 acquires differences (0, 3, CN_{S}-CN₁, 0, . . . Sₛ-S₁, Vₛ-V₁, Cₛ-C₁, CCₛ-CC₁, Tₛ-T₁, . . . ) for the respective attributes. It is assumed that information indicating that the elements of the vector of the differences for the respective attributes respectively correspond to the attribute identifiers (cashless or not, year, number of products that can be offered, presence or absence of feature 1, . . . , sales, number of visits, number of inquiries, number of product changes, sell-out time, . . . ) is stored in the attribute determination part 1334.

Next, the attribute determination part 1334 determines, for each attribute value difference, whether or not the difference satisfies a defectiveness condition, Then, it is assumed that the attribute determination part 1334 acquires and “number of inquiries” as attribute identifiers satisfying the defectiveness condition.

Next, the improv it acquisition part 1335 acquires improvement information “improvement measure 3” paired with the acquired attribute identifier “year” , from the improvement management table (FIG. 12). The improvement acquisition part 1335 acquires improvement information “improvement measure 2” paired with the acquired attribute identifier “number of inquiries”, from the improvement management table (FIG. 12). Next, the improvement output unit 142 transmits the improvement information “improvement measure 2” and “improvement measure 3” to the terminal apparatus 2.

Next, the terminal apparatus 2 receives and outputs the improvement information “improvement measure 2” and “improvement measure 3”.

As described above, according to this embodiment, it is possible to assist in taking measures to deter the removal of an offering apparatus 3, by outputting a removal score thereof. In particular, according to this embodiment, it is possible to assist in taking measures to deter the removal of an offering apparatus, by outputting a removal score thereof, using machine learning. Furthermore, according to this embodiment, it is possible to assist in taking measures to deter the removal of an offering apparatus, by outputting a removal score thereof, using a correspondence table. Furthermore, according to this embodiment, it is possible to assist in taking measures to deter the removal of an offering apparatus, by outputting a removal score thereof, using an operation expression. In this embodiment, the method for acquiring the removal score may be any other method.

Furthermore, according to this embodiment, it is possible to output improvement information for deterring the removal of an offering apparatus 3. Furthermore, according to this embodiment, it is possible to output improvement information for deterring the removal of an offering apparatus with a high level of precision, in particular using machine learning. Furthermore, according to this embodiment, it is possible to output improvement information for deterring the removal of an offering apparatus at high speed, using standard attribute values of the offering apparatus. In this embodiment, the method for acquiring the improvement information may be any other method.

In this embodiment, the information processing apparatus 1 may be a stand-alone apparatus. The block diagram of the information processing apparatus 1 in this case is shown in FIG. 2 as a block diagram of the information processing apparatus 1. The acceptance unit 12 of the information processing apparatus 1 typically accepts various types of instructions and information from users. The acceptance unit 12 accepts, for example, a score output instruction having one or more attribute values of an offering apparatus 3 from users. The acceptance unit 12 accepts, for example, an improvement output instruction having one or more attribute values of an offering apparatus 3 from users. The output unit 14, the score output unit 141, and the improvement output unit 142 of the information processing apparatus 1 display information typically on a display screen. The information processing apparatus 1 may not include the apparatus management unit 111.

The processing in this embodiment may be realized by software. The software may be distributed by software downloads or the like. Furthermore, the software may be distributed in a form where the software is stored in a recording medium such as a CD-ROM. The same applies to other embodiments in this specification. The software that realizes the information processing apparatus I in this embodiment is the following sort of program. Specifically, this program is a program for causing a computer to function as: a score acquisition unit that acquires a removal score regarding removal of an offering apparatus that offers an article, the removal score being acquired using one or more attribute values of the offering apparatus and a score output unit that outputs the removal score acquired by the score acquisition unit.

It should be noted that, in the program, in a step of transmitting information, a step of receiving information, or the like, processing that is performed by hardware, for example, processing performed by a modem or an interface card in the transmitting step (processing that can be performed only by hardware is not included.

Furthermore, the computer that executes the program may be constituted by a single computer, or constituted by multiple computers. That is to say, centralized processing may be performed, or distributed processing may be performed.

Furthermore, in the foregoing embodiment, it will be appreciated that two or more communication parts in one apparatus may be physically realized by one medium.

Furthermore, in the foregoing embodiment, each process may be realized as centralized processing using a single apparatus, or may be realized as distributed processing using multiple apparatuses.

The present invention is not limited to the embodiments set forth herein. Various modifications are possible within the scope of the present invention.

### Industrial Applicability

As described above, the information processing apparatus 1 according to the present invention has an effect of making it possible to assist in deterring the removal of installed offering apparatuses, thus rendering this apparatus useful as a server and the like for providing information.

1. An information processing apparatus comprising:
an attribute value acquisition unit that acquires one or more attribute values of one offering apparatus that is a vending machine, a beer server, or a tea serving machine, from an apparatus management unit in which one or more pieces of apparatus information each having one or more attribute values of an offering apparatus are stored;
a score acquisition unit that acquires a removal score regarding removal of the one offering apparatus, using the one or more attribute values; and
a score output unit that outputs the removal score acquired by the score acquisition unit,
wherein the score acquisition unit includes:
a score model acquisition part that acquires a score learning model, from a storage unit having stored therein the score learning model acquired through learning processing of machine learning using two or more pieces of training data each having one or more attribute values and a removal score; and a score acquisition part that acquires the removal score by performing prediction processing of machine learning using the one or more attribute values acquired by the attribute value acquisition unit and the score learning model, or
a vector acquisition part that acquires a vector having one or more elements respectively based on the one or more attribute values acquired by the attribute value acquisition unit; and a score acquisition part that, referring to a correspondence table containing two or more pieces of correspondence information each having a vector having one or more elements respectively based on one or more attribute values of an offering apparatus and a removal score, acquires the removal score, using a removal score paired with a vector that satisfies a similarity condition to the vector acquired by the vector acquisition part, or
a score acquisition part that acquires the removal score, by substituting each of the one or more attribute values acquired by the attribute value acquisition unit for an operation expression, and executing the operation expression.

2. The information processing apparatus according to claim 1,
wherein each of the one or more attribute values is a dynamic attribute value or a static attribute value,
the dynamic attribute value is one or more of the number of visits, the number of inquiries, the number of product changes, the number of setting changes, contact person information, operating information, a contract duration, and a remaining contract period,
the static attribute value is one or more of hardware information of the offering apparatus and installation location information of the offering apparatus,
the hardware information is presence or absence of a cashless purchase method, presence or absence of user terminal communication support, presence or absence of management communication, year, the number of products that can be offered, the quantity of products that can be sold, accessory equipment information, power consumption, presence or absence of disaster support, or presence or absence of signage, and
the installation location information is information for specifying a floor, information for specifying an indoor or outdoor location, or adjacent-setup combined-selling information.

3. The information processing apparatus according to claim 2,
wherein the attribute value acquisition unit acquires two or more attribute values of the one offering apparatus,
the score acquisition unit acquires the removal score, using the two or more attribute values, and
the two or more attribute values include the dynamic attribute value and the static attribute value.

4. An information processing apparatus comprising:
an attribute value acquisition unit that acquires one or more attribute values of one offering apparatus that offers an article, from an apparatus management unit in which one or more pieces of apparatus information each having one or more attribute values of an offering apparatus are stored;
an improvement acquisition unit that acquires improvement information for preventing removal of the one offering apparatus, using the one or more attribute values acquired by the attribute value acquisition unit; and
an improvement output unit that outputs the improvement information acquired by the improvement acquisition unit,
wherein the improvement acquisition unit includes:
an improvement model acquisition part that acquires an improvement learning model from a storage unit having stored therein the improvement learning model acquired through learning processing of machine learning using two or more pieces of training data each having one or more attribute values of an offering apparatus and an improvement information identifier for identifying improvement information; an improvement prediction part that acquires an improvement identifier by performing prediction processing of machine learning using the one or more attribute values acquired by the attribute value acquisition unit and the improvement learning model; and an improvement acquisition part that acquires improvement information identified with the improvement identifier acquired by the improvement prediction part, from an improvement management unit in which improvement information identified with the improvement information identifier is stored, or
an improvement model acquisition part that, for each piece of improvement information, acquires an improvement learning model from a storage unit having stored therein the improvement learning model acquired through learning processing of machine learning using two or more pieces of training data each having one or more attribute values of an offering apparatus and result information (information indicating “improved” or information indicating “not improved”) regarding removal obtained by implementing improvement indicated by the improvement information; an improvement prediction part that, for each piece of improvement information, performs prediction processing of machine learning using the one or more attribute values acquired by the attribute value acquisition unit and the improvement learning model paired with the improvement information, thereby acquiring result information; and an improvement acquisition part that acquires one or more pieces of the improvement information corresponding to the “improved” result information acquired by the improvement prediction part, or
a standard acquisition part that acquires standard attribute values respectively for one or more attributes of an offering apparatus, from a standard management unit in which the standard attribute values respectively for the one or more attributes are stored; an attribute determination part that respectively compares, for the one or more attributes of the offering apparatus, the attribute values acquired by the attribute value acquisition unit and the standard attribute values, and determines defectiveness attributes satisfying defectiveness conditions of attribute values that are not good compared with the standard attribute values; and an improvement acquisition part that acquires pieces of improvement information respectively corresponding to attribute identifiers of the defectiveness attributes, from an improvement management unit in which pieces of improvement information respectively associated with one or more attribute identifiers are stored.

5. The information processing apparatus according to claim 4, further comprising:
a score acquisition unit that acquires a removal score regarding removal of the one offering apparatus, using the one or more attribute values
wherein the score acquisition unit includes:
a score model acquisition part that acquires a score learning model, from a storage unit having stored therein the score learning model acquired through learning processing of machine learning using two or more pieces of training data each having one or more attribute values and a removal score; and a score acquisition part that acquires the removal score by performing prediction processing of machine learning using the one or more attribute values acquired by the attribute value acquisition unit and the score learning model, or
a vector acquisition part that acquires a vector having one or more elements respectively based on the one or more attribute values acquired by the attribute value acquisition unit; and a score acquisition part that, referring to a correspondence table containing two or more pieces of correspondence information each having a vector having one or more elements respectively based on one or more attribute values of an offering apparatus and a removal score, acquires the removal score, using a removal score paired with a vector that satisfies a similarity condition to the vector acquired by the vector acquisition part, or
a score acquisition part that acquires the removal score, by substituting each of the one or more attribute values acquired by the attribute value acquisition unit for an operation expression, and executing the operation expression, and
the improvement acquisition unit acquires the improvement information only in a case in which the removal score is greater than or equal to a threshold value or is greater than a threshold value.

6. The information processing apparatus according to claim 4 ,
wherein the offering apparatus is a vending machine,
each of the one or more attribute values is a dynamic attribute value or a static attribute value,
the dynamic attribute value is sales-related information, the number of visits, the number of inquiries, the number of product changes, the number of setting changes, contact person information, operating information, a contract duration, or a remaining contract period,
the static attribute value is hardware information of the offering apparatus or installation location information of the offering apparatus,
the hardware information is presence or absence of a cashless purchase method, presence or absence of user terminal communication support, presence or absence of management communication, year, the number of products that can be offered, the quantity of products that can be sold, accessory equipment information, power consumption, presence or absence of disaster support, or presence or absence of signage, and
the installation location information is information for specifying place of purchase, information for specifying a floor, information for specifying an indoor or outdoor location, an address, counterparty information, or adjacent-setup combined-selling information.

7. An information processing method realized using an information processing apparatus including an attribute value acquisition unit, a score acquisition unit, and a score output unit, comprising:
an attribute value acquisition step in which the attribute value acquisition unit acquires one or more attribute values of one offering apparatus that is a vending machine, a beer server, or a tea serving machine, from an apparatus management unit in which one or more pieces of apparatus information each having one or more attribute values of an offering apparatus are stored;
a score acquisition step in which the score acquisition unit acquires a removal score regarding removal of the one offering apparatus, using the one or more attribute values; and
a score output step in which the score output unit outputs the removal score acquired by the score acquisition unit,
wherein the score acquisition step includes:
a score model acquisition sub-step of acquiring a score learning model, from a storage unit having stored therein the score learning model acquired through learning processing of machine learning using two or more pieces of training data each having one or more attribute values and a removal score; and a score acquisition sub-step of acquiring the removal score by performing prediction processing of machine learning using the one or more attribute values acquired by the attribute value acquisition unit and the score learning model, or
a vector acquisition sub-step of acquiring a vector having one or more elements respectively based on the one or more attribute values acquired by the attribute value acquisition unit; and a score acquisition part that, referring to a correspondence table containing two or more pieces of correspondence information each having a vector having one or more elements respectively based on one or more attribute values of an offering apparatus and a removal score, acquires the removal score, using a removal score paired with a vector that satisfies a similarity condition to the vector acquired by the vector acquisition part, or
a score acquisition sub-step of acquiring the removal score, by substituting each of the one or more attribute values acquired by the attribute value acquisition unit for an operation expression, and executing the operation expression.

8-10. (canceled)
